(19) United States
(12) Patent Application Publication
(10) Pub. No.: US 2025/0389846 A1
(43) Pub. Date: Dec. 25, 2025

(54) SIGNAL PROCESSING DEVICE, SONIC WAVE SYSTEM, AND VEHICLE

(71) Applicant: ROHM CO., LTD., Kyoto (JP)

(72) Inventor: Shogo TAKAMURA, Kyoto (JP)

(21) Appl. No.: 19/306,249

(22) Filed: Aug. 21, 2025

Related U.S. Application Data
(63) Continuation of application No. PCT/JP2023/046674, filed on Dec. 26, 2023.

(30) Foreign Application Priority Data
Feb. 27, 2023 (JP) 2023-028218

(51) Int. Cl. G01S 15/08; G01S 7/52; G01S 15/931

(52) U.S. Cl. CPC G01S 15/08; G01S 7/52; G01S 15/931

(57) ABSTRACT

A signal processing device is configured to output, via a transformer to a sonic wave transmission device, a transmission signal for transmitting a sonic wave. The signal processing device includes a resonance frequency measuring portion. The resonance frequency measuring portion is configured to find the resonance frequency of the sonic wave transmission device from at least one of a first frequency at which, while the frequency of the transmission signal is down-chirped, the amplitude of the secondary voltage of the transformer is at its minimum and a second frequency at which, while the frequency of the transmission signal is up-chirped, the amplitude of the secondary voltage of the transformer is at its minimum.

### CROSS REFERENCE TO RELATED APPLICATIONS

This application is a continuation under 35 U.S.C. § 120 of PCT/JP2023/046674 filed on Dec. 26, 2023, which is incorporated herein by reference, and which claimed priority Japanese Patent Application No. 2023-028218 filed Feb. 27, 2023, the entire contents of which is also hereby incorporated by reference.

### BACKGROUND OF THE INVENTION

### 1. Technical Field

The invention herein disclosed relates to a signal processing device that processes a transmission signal for transmitting a sonic wave, a sonic wave system that includes such a signal processing device, and a vehicle that incorporates such a sonic wave system.

### 2. Description of Related Art

Known ultrasonic wave systems generate an ultrasonic wave and measure the TOF (time of flight) of its reflection wave from an obstacle to measure the distance to the obstacle. Such an ultrasonic wave system is commonly incorporated in a vehicle, of which one example is a vehicle-on-board clearance sonar (e.g., see WO2020/004609).

### BRIEF DESCRIPTION OF DRAWINGS

FIG. 1 is a diagram schematically showing a vehicle incorporating an ultrasonic wave system according to an embodiment along with an object.

FIG. 2 is a diagram showing the configuration of the ultrasonic wave system according to the embodiment.

FIG. 3 is a diagram showing an equivalent circuit of an ultrasonic wave transmission device.

FIG. 4 is a diagram showing the waveform of the secondary voltage of a transformer when the frequency of a transmission signal is down-chirped.

FIG. 5 is a diagram showing the waveform of the secondary voltage of the transformer when the frequency of the transmission signal is up-chirped.

FIG. 6 is a diagram showing the configuration of an ultrasonic wave system according to a modified example.

### DESCRIPTION OF EMBODIMENTS

Now, an embodiment will be described with reference to the accompanying drawings. Note that the ultrasonic wave system according to the embodiment described below is assumed to be incorporated in a vehicle by way of an example, and thus it is applicable, owing to its ability to measure the distance between the vehicle and an object, to an alerting function, an automatic braking function, an automatic parking function, and the like.

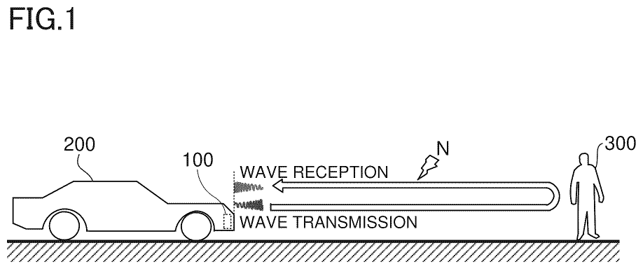

FIG. 1 is a diagram schematically showing a vehicle 200 incorporating an ultrasonic wave system 100 according to the embodiment along with an object (obstacle) 300. An ultrasonic wave transmitted from the ultrasonic wave system 100 according to the embodiment is reflected from the object 300 and is then received as a reflection wave by the ultrasonic wave system 100 according to the embodiment. At the same time, the ultrasonic wave system 100 also receives environmental noise N. The environmental noise N includes another ultrasonic wave (another wave) transmitted from another ultrasonic wave system.

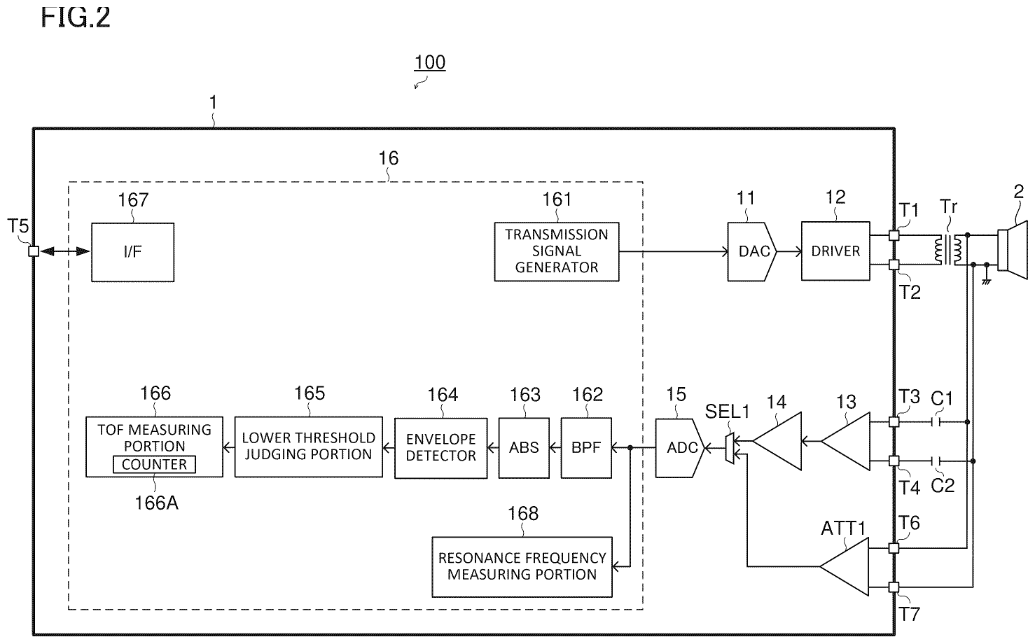

FIG. 2 is a diagram showing the configuration of the ultrasonic wave system 100 according to the embodiment.

The ultrasonic wave system 100 includes a signal processing device 1, a transformer Tr, capacitors C1 and C2, and an ultrasonic wave transmission device 2. The ultrasonic wave transmission device 2 is externally connected to the signal processing device 1 via the transformer Tr and the capacitors C1 and C2.

The signal processing device 1 is a semiconductor integrated circuit device. The signal processing device 1 includes a DAC (digital to analog converter) 11, a driver 12, an LNA (low noise amplifier) 13, a PGA (programmable gain amplifier) 14, an ADC (analog to digital converter) 15, a digital processor 16, an attenuator ATT1, a selector SEL1, and external terminals T1 to T7.

The DAC 11 performs D/A conversion to convert a transmission signal output from a transmission signal generator 161 included in the digital processor 16 from a digital signal to an analog signal and outputs the D/A converted signal to the driver 12.

The output terminals of a differential pair in the driver 12 are connected via the external terminals T1 and T2 to the primary side of the transformer Tr. To the secondary side of the transformer Tr, the ultrasonic wave transmission device 2 is connected. The driver 12 drives based on the output signal of DAC 11 the ultrasonic wave transmission device 2.

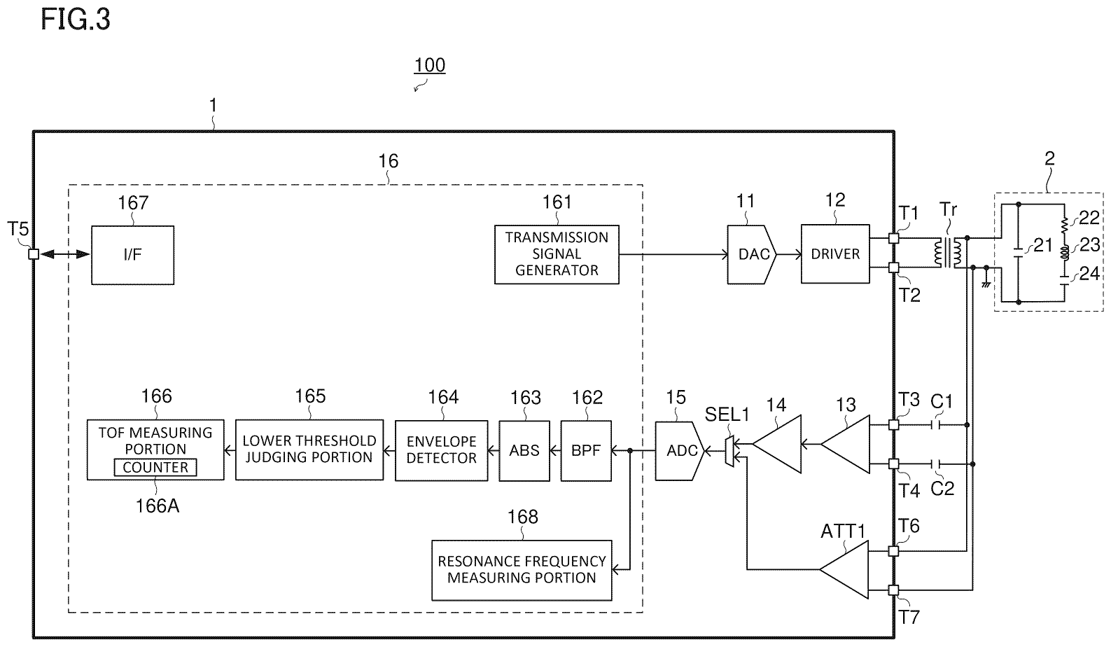

The ultrasonic wave transmission device 2 includes a piezoelectric element not shown and transmits and receives an ultrasonic wave. That is, the ultrasonic wave transmission device 2 is an ultrasonic wave transmission/reception device that functions not only as a sound source but also as a receiver. The ultrasonic wave transmission device 2 can be configured to have a piezoelectric element shared between wave transmission and wave reception or to have a piezoelectric element dedicated to wave transmission and a piezoelectric element dedicated to wave reception. FIG. 3 is a diagram showing an equivalent circuit of the ultrasonic wave transmission device 2. The equivalent circuit of the ultrasonic wave transmission device 2 includes a capacitor 21, a resistor 22, an inductor 23, and a capacitor 24. The first terminals of the capacitor 21 and the resistor 22 are connected to the first terminal of the secondary winding of the transformer Tr. The second terminal of the resistor 22 is connected to the first terminal of the inductor 23. The second terminal of the inductor 23 is connected to the first terminal of the capacitor 24. The second terminals of the capacitors 21 and 24 are connected to the second terminal of the secondary winding of the transformer Tr.

The input terminals of a differential pair in the LNA 13 are connected via the external terminals T3 and T4 and the capacitors C1 and C2 to the secondary side of the transformer Tr. The LNA 13 amplifies differential signals received from the external terminals T3 and T4 and converts them to a single-end signal to output it to the PGA 14. The LNA 13 also clips the single-end signal so that it does not exceed a predetermined level. The PGA 14 amplifies the signal received from the LNA 13 to output the result via the selector SEL1 to the ADC 15. The ADC 15 performs A/D conversion to convert the output signal of the PGA 14 from the analog signal into a digital signal and then outputs the A/D converted signal to a BPF 162 and to a resonance frequency measuring portion 168. Note that the sampling frequency of the ADC 15 is higher than the frequency of the transmission signal.

The selector SEL1 selects, in a mode where the signal processing device 1 receives an ultrasonic wave, the output signal of the PGA 14 to feed it to the ADC 15 and selects, in a mode where the signal processing device 1 measures the resonance frequency, the output signal of the attenuator ATT1 to feed it to the ADC 15.

The digital processor 16 includes a transmission signal generator 161, a BPF (band pass filter) 162, an ABS (absolute value processor) 163, an envelope detector 164, a lower threshold judging portion 165, a TOF measuring portion 166, an interface 167, and a resonance frequency measuring portion 168.

The transmission signal generator 161 is configured to generate a transmission signal for transmitting an ultrasonic wave. Specifically, on receiving a transmission command via the interface 167 from an ECU (electronic control unit) not shown incorporated in the vehicle 200 (see FIG. 1), the transmission signal generator 161 generates a transmission signal including a predetermined number of waves to output the transmission signal to the DAC 11.

The BPF 162 lets pass the output signal of the ADC 15 only in a predetermined frequency band and attenuates it in any frequency bands other than the predetermined frequency band. The BPF 162 has frequency characteristics corresponding to the frequency setting of the transmission signal. For example, the predetermined frequency band is set so as to match the frequency band of the transmission signal. The frequency band of the environmental noise N is unlikely to match the frequency band of the transmission signal, so that the BPF 162 can normally remove the environmental noise N.

The ABS 163 performs absolute value calculation on the output signal of the BPF 162. That is, the ABS 163 performs inversion on a negative output signal of the BPF 162 to convert it into a positive signal.

The envelope detector 164 detects the envelope of the output signal of the ABS 163 to output the resulting signal.

The lower threshold judging portion 165 compares the output signal of the envelope detector 164 with a lower threshold value. If the output signal of the envelope detector 164 becomes larger than the lower threshold value, the lower threshold judging portion 165 detects the reflection wave from the object 300.

The TOF measuring portion 166 measures with a counter 166A the time (TOF) from the transmission of the ultrasonic wave to the reception of the reflection wave from the object 300.

The interface 167 conforms to LIN (Local Interconnect Network) as an example to communicate the ECU not shown incorporated in the vehicle 200 (see FIG. 1) via the external terminal T5.

The input terminals of a differential pair in the attenuator ATT1 are connected via the external terminals T6 and T7 to the secondary side of the transformer Tr. The attenuator ATT1 attenuates the amplitudes of differential signals received from the external terminals T6 and T7 and converts them to a single-end signal to output it via the selector SEL1 to the ADC 15. The ADC 15 performs A/D conversion to convert the output signal of the PGA 14 from the analog signal to a digital signal and outputs the A/D converted signal to the BPF 162 and to the resonance frequency measuring portion 168. The provision of the attenuator ATT1 allows the measurement of the amplitude of the secondary voltage of the transformer Tr with no increase in the withstand voltage of the digital processor 16.

Now, the operation of the signal processing device 1 in a mode where it measures the resonance frequency will be described.

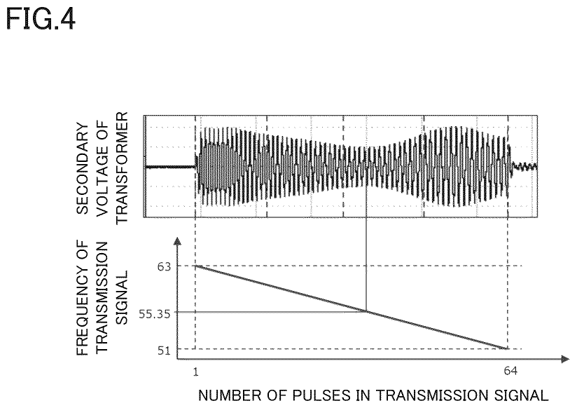

The transmission signal generator 161 down-chirps, that is, decreases, the frequency of the transmission signal. For example, the transmission signal generator 161 decreases the frequency of the transmission signal from 63 kHz to 51 kHz pulse by pulse at equal intervals to output a transmission signal with 64 pulses. The waveform of the secondary voltage of the transformer Tr meanwhile is as shown in FIG. 4, at top.

The equivalent circuit (see FIG. 3) of the ultrasonic wave transmission device 2 has a complex impedance. The complex impedance is at its minimum at the resonance frequency of the ultrasonic wave transmission device 2. With the complex impedance of the equivalent circuit of the ultrasonic wave transmission device 2 at its minimum, the secondary voltage of the transformer Tr is at its minimum. Accordingly, the resonance frequency measuring portion 168 measures, for every different frequency of the transmission signal, the amplitude of the secondary voltage of the transformer Tr.

The ultrasonic wave transmission device 2 however has a poor response, with its vibration following, with a delay, the frequency of the transmission signal. Thus, the frequency of the transmission signal shown in FIG. 4 with the amplitude of the secondary voltage of the transformer Tr at its minimum has a value (55.35 kHz in the example shown in FIG. 4) slightly lower than the resonance frequency of the ultrasonic wave transmission device 2.

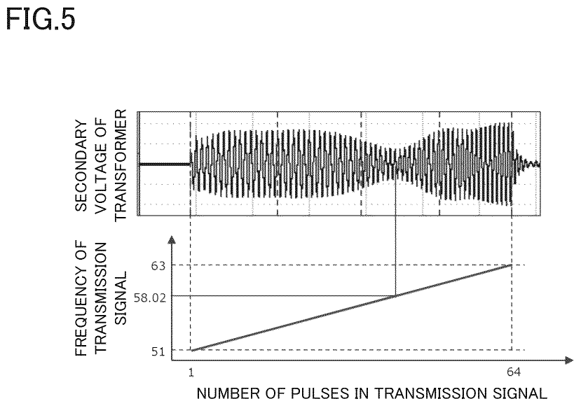

Next, the transmission signal generator 161 up-chirps, that is, increases, the frequency of the transmission signal. For example, the transmission signal generator 161 increases the frequency of the transmission signal from 51 kHz to 63 kHz pulse by pulse at equal intervals to output a transmission signal with 64 pulses. The waveform of the secondary voltage of the transformer Tr meanwhile is as shown in FIG. 5, at top.

The equivalent circuit (see FIG. 3) of the ultrasonic wave transmission device 2 has a complex impedance. The complex impedance is at its minimum at the resonance frequency of the ultrasonic wave transmission device 2. With the complex impedance of the equivalent circuit of the ultrasonic wave transmission device 2 at its minimum, the secondary voltage of the transformer Tr is at its minimum. Accordingly, the resonance frequency measuring portion 168 measures, for every different frequency of the transmission signal, the amplitude of the secondary voltage of the transformer Tr.

The ultrasonic wave transmission device 2 however has a poor response, with its vibration following, with a delay, the frequency of the transmission signal. Thus, the frequency of the transmission signal shown in FIG. 5 with the amplitude of the secondary voltage of the transformer Tr at its minimum has a value (58.02 kHz in the example shown in FIG. 5) slightly higher than the resonance frequency of the ultrasonic wave transmission device 2.

The resonance frequency measuring portion 168 finds the resonance frequency of the ultrasonic wave transmission device 2 from the average of a first frequency at which, while the frequency of the transmission signal is down-chirped, the amplitude of the secondary voltage of the transformer Tr is at its minimum and a second frequency, at which, while the frequency of the transmission signal is up-chirped, the amplitude of the secondary voltage of the transformer Tr is at its minimum. Specifically, the resonance frequency measuring portion 168 takes, as the resonance frequency of the ultrasonic wave transmission device 2, the simple average (56.68 kHz= (55.35 kHz+58.02 kHz)/2 in the examples shown in FIG. 4 and FIG.5) of a first frequency at which, while the frequency of the transmission signal is down-chirped, the amplitude of the secondary voltage of the transformer Tr is at its minimum and a second frequency, at which, while the frequency of the transmission signal is up-chirped, the amplitude of the secondary voltage of the transformer Tr is at its minimum.

Note that, in the embodiment, the transmission signal generator 161 uses the same rate of change of frequency during down-chirping and up-chirping.

The averaging described above by the resonance frequency measuring portion 168 virtually cancels the delay of the response of the ultrasonic wave transmission device 2 and improves the accuracy of the measurement of the resonance frequency by the ultrasonic wave transmission device 2.

As a modified example of the embodiment, the resonance frequency measuring portion 168 can take, as the resonance frequency of the ultrasonic wave transmission device 2, the weighted average of a first frequency at which, while the frequency of the transmission signal is down-chirped, the amplitude of the secondary voltage of the transformer Tr is at its minimum and a second frequency, at which, while the frequency of the transmission signal is up-chirped, the amplitude of the secondary voltage of the transformer Tr is at its minimum. The weighted average is useful in a case where the ultrasonic wave transmission device 2 responds with different delays during down-chirping and up-chirping.

The ultrasonic wave transmission device 2 can respond with different delays during down-chirping and up-chirping, for example, in a case where the transmission signal generator 161 sets different rates of change of frequency during down-chirping and up-chirping or in a case where the environment differs greatly during down-chirping and up-chirping. In such cases, the resonance frequency measuring portion 168 can take the weighted average.

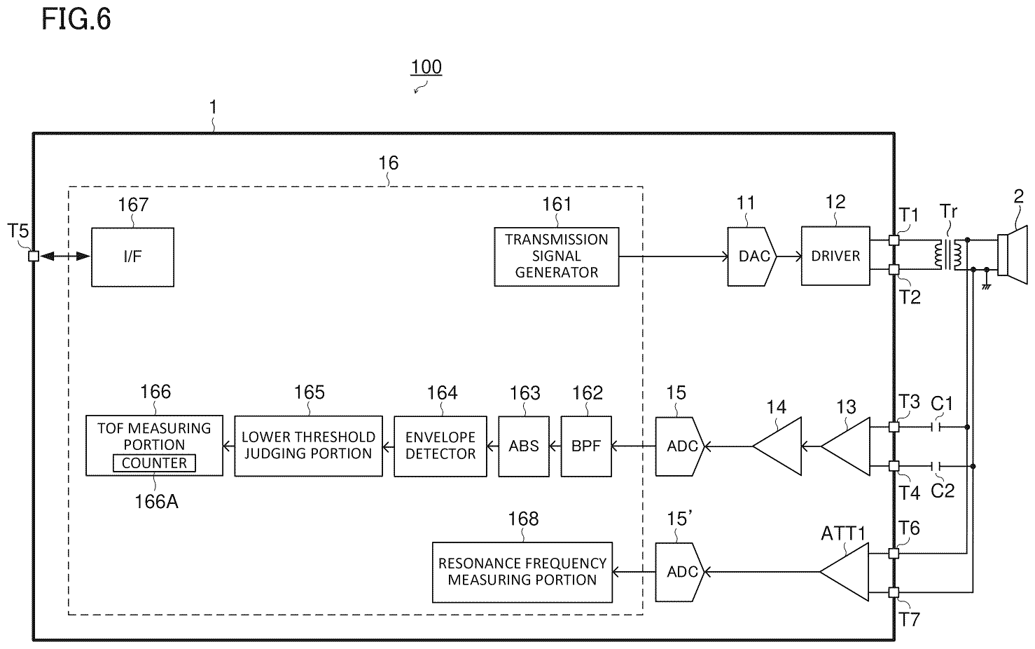

In the embodiment, between the mode where the signal processing device 1 receives the ultrasonic wave and the mode where the signal processing device 1 measures the resonance frequency, the ADC 15 is shared. Instead, as shown in a modified example in FIG. 6, the signal processing device 1 can be configured to disuse the selector SEL1 and have an ADC 15 dedicated to the mode where the signal processing device 1 receives the ultrasonic wave and an ADC 15′ dedicated to the mode where the signal processing device 1 measures the resonance frequency.

### Others

The embodiments disclosed herein may be modified in various ways, as appropriate, without departing from the scope of the technical concept disclosed in the appended claims. The individual embodiments described hereinabove may be carried out in combination between or among those embodiments unless any contradiction is involved. The above-described embodiments are only examples of embodiment of the present disclosure, and senses of terms in the disclosure or respective configurational components are not particularly limited to those described in the embodiments.

While the above embodiment deals with an ultrasonic wave system 100 that transmits an ultrasonic wave (a sonic wave with a frequency higher than audible frequencies), the invention herein disclosed can be applied to sonic wave systems that transmit any sonic waves other than ultrasonic waves.

In the above embodiment, the resonance frequency measuring portion 168 finds the resonance frequency of the ultrasonic wave transmission device 2 from the average of a first frequency at which, while the frequency of the transmission signal is down-chirped, the amplitude of the secondary voltage of the transformer Tr is at its minimum and a second frequency, at which, while the frequency of the transmission signal is up-chirped, the amplitude of the secondary voltage of the transformer Tr is at its minimum. Instead, the resonance frequency measuring portion 168 can find the resonance frequency of the ultrasonic wave transmission device 2 from either a first frequency at which, while the frequency of the transmission signal is down-chirped, the amplitude of the secondary voltage of the transformer Tr is at its minimum or a second frequency, at which, while the frequency of the transmission signal is up-chirped, the amplitude of the secondary voltage of the transformer Tr is at its minimum.

When finding the resonance frequency of the ultrasonic wave transmission device 2 from either the first frequency or the second frequency, the resonance frequency measuring portion 168 can estimate the delay in the response of the ultrasonic wave transmission device 2 based on the output signal of a sensor configured to sense the environment. The reason is that the delay in the response of the ultrasonic wave transmission device 2 depends on the circuit constants of the equivalent circuit of the ultrasonic wave transmission device 2 and the circuit constants of the equivalent circuit of the ultrasonic wave transmission device 2 vary depending on the environment of the ultrasonic wave transmission device 2. The sensor configured to sense the environment can be, for example, a temperature sensor configured to sense the ambient temperature. The sensor configured to sense the environment can be housed in the signal processing device 1 or can be externally connected to the signal processing device 1. Considering however, that providing the sensor configured to sense the environment near the ultrasonic wave transmission device 2 helps improve accuracy of the estimation of the delay in the response of the ultrasonic wave transmission device 2, the sensor configured to sense the environment is preferably provided near the ultrasonic wave transmission device 2.

### Notes

To follow are notes on what is disclosed herein, of which a specific example of configuration is described above as an embodiment.

According to one aspect of the present disclosure, a signal processing device (1) is a signal processing device configured to output, via a transformer (Tr) to a sonic wave transmission device (2), a transmission signal for transmitting a sonic wave and it includes a resonance frequency measuring portion (168). The resonance frequency measuring portion is configured to find the resonance frequency of the sonic wave transmission device from at least one of a first frequency at which, while the frequency of the transmission signal is down-chirped, the amplitude of the secondary voltage of the transformer is at its minimum and a second frequency at which, while the frequency of the transmission signal is up-chirped, the amplitude of the secondary voltage of the transformer is at its minimum (a first configuration).

In the signal processing device according to the first configuration described above, the resonance frequency measuring portion can be configured to find the resonance frequency of the sonic wave transmission device from the average of the first and second frequencies (a second configuration).

In the signal processing device according to the second configuration described above, the average can be the simple average of the first and second frequencies (a third configuration).

In the signal processing device according to the third configuration described above, the rates of change of frequency during down-chirping and up-chirping can be equal (a fourth configuration).

In the signal processing device according to the second configuration described above, the average can be the weighted average of the first and second frequencies (a fifth configuration).

In the signal processing device according to the fifth configuration described above, the rates of change of frequency during down-chirping and up-chirping can be different from each other (a sixth configuration).

In the signal processing device according to the first configuration described above, the resonance frequency measuring portion can be configured to find the resonance frequency of the sonic wave transmission device from either the first or second frequency and the output signal of a sensor configured to sense the environment (a seventh configuration).

The signal processing device according to any one of the first to seventh configurations described above can further include an attenuator (ATT1) configured to attenuate the secondary voltage of the transformer (an eighth configuration).

According to another aspect of the present disclosure, a sonic wave system (100) includes the signal processing device according to any one of the first to eighth configurations described above, the transformer, and the sonic wave transmission device (a ninth configuration).

According to still another aspect of the present disclosure, a vehicle (200) includes the sonic wave system according to the ninth configuration described above (a tenth configuration).

What is claimed is:

1. A signal processing device configured to output, via a transformer to a sonic wave transmission device, a transmission signal for transmitting a sonic wave, comprising a resonance frequency measuring portion,
wherein
the resonance frequency measuring portion is configured to find a resonance frequency of the sonic wave transmission device from at least one of
a first frequency at which, while a frequency of the transmission signal is down-chirped, an amplitude of a secondary voltage of the transformer is at a minimum thereof and
a second frequency at which, while the frequency of the transmission signal is up-chirped, the amplitude of the secondary voltage of the transformer is at the minimum thereof.

2. The signal processing device according to claim 1, wherein
the resonance frequency measuring portion is configured to find the resonance frequency of the sonic wave transmission device from an average of the first and second frequencies.

3. The signal processing device according to claim 2, wherein
the average is a simple average of the first and second frequencies.

4. The signal processing device according to claim 3, wherein
rates of change of frequency during down-chirping and up-chirping are equal.

5. The signal processing device according to claim 2, wherein
the average is a weighted average of the first and second frequencies.

6. The signal processing device according to claim 5, wherein
rates of change of frequency during down-chirping and up-chirping are different from each other.

7. The signal processing device according to claim 1, wherein
the resonance frequency measuring portion is configured to find the resonance frequency of the sonic wave transmission device from either the first or second frequency and an output signal of a sensor configured to sense an environment.

8. The signal processing device according to claim 1 further comprising
an attenuator configured to attenuate the secondary voltage of the transformer.

9. A sonic wave system comprising:
the signal processing device according to claim 1;
the transformer; and
the sonic wave transmission device.

10. A vehicle comprising the sonic wave system according to claim 9.
